(19) United States
(12) Patent Application Publication
(10) Pub. No.: US 2021/0049649 A1
(43) Pub. Date: Feb. 18, 2021

(54) DYNAMICALLY STREAMING SOCIAL MEDIA LIVE CONTENT AND DISPLAYING ADVERTISEMENTS ON A PUBLIC DISPLAY

(71) Applicant: International Business Machines Corporation, Armonk, NY (US)

(72) Inventors: Vagner Figueredo de Santana, São Paulo (BR); Ana Paula Appel, São Paulo (BR); Renato Luiz de Freitas Cunha, São Paulo (BR); Alecio Pedro Delazari Binotto, Sao Paulo (BR)

(21) Appl. No.: 16/539,527

(22) Filed: Aug. 13, 2019

(51) Int. Cl. G06Q 30/02; G06Q 50/00

(52) U.S. Cl. CPC G06Q 30/0277; G06Q 30/0255; G06Q 50/01

(57) ABSTRACT

A computer-implemented method, a computer program product, and a computer system for dynamically streaming social media live content and displaying advertisements. A server identifies characteristics of crowd members who log in wireless network access points in an environment having displays and consume social media live content produced by digital influencers. The server extracts features of the social media live content. The server matches the social media live content to the crowd members, based on the features of the social media live content and the characteristics of the crowd members. The server determines selected social media live content. The server matches the selected social media live content to advertisements, based on the features of the social media live content and information of the advertisements. The server determines selected advertisements. The server streams the selected social media live content and displays the selected advertisements on the displays.

### BACKGROUND

The present invention relates generally to promoting public displays and reducing banner blindness, and more particularly to a computer-implemented approach to dynamically streaming social media live content and displaying advertisements on a public display.

Public displays are an expensive advertising channel and often suffer from what is called banner blindness. In the situation of the banner blindness, users learn or infer the type of content that is going to be presented in certain places, and users tend to ignore the content once they learn that specific places are used to receive only advertisements.

### SUMMARY

In one aspect, a computer-implemented method for dynamically streaming social media live content and displaying advertisements is provided. The computer-implemented method is implemented by a server. The computer-implemented method includes identifying characteristics of crowd members, wherein the crowd members log in one or more wireless network access points and consume social media live content in an environment having one or more displays, and wherein one or more digital influencers produce the social media live content in the environment. The computer-implemented method further includes extracting one or more features of the social media live content. The computer-implemented method further includes matching the social media live content to the crowd members, based on the one or more features of the social media live content and the characteristics of the crowd members. The computer-implemented method further includes determining selected social media live content, based on the matching the social media live content to the crowd members. The computer-implemented method further includes matching the selected social media live content to one or more advertisements, based on the one or more features and information of the one or more advertisements. The computer-implemented method further includes determining one or more selected advertisements, based on the matching the selected social media live content to the one or more advertisements. The computer-implemented method further includes streaming the selected social media live content on the one or more displays. The computer-implemented method further includes displaying the one or more selected advertisements on the one or more displays.

In another aspect, a computer program product for dynamically streaming social media live content and displaying advertisements is provided. The computer program product comprising one or more computer-readable tangible storage devices and program instructions stored on at least one of the one or more computer-readable tangible storage devices. The program instructions are executable to identify characteristics of crowd members, wherein the crowd members log in one or more wireless network access points and consume social media live content in an environment having one or more displays, and wherein one or more digital influencers produce social media live content in the environment. The program instructions are further executable to extract one or more features of the social media live content. The program instructions are further executable to match the social media live content to the crowd members, based on the one or more features of the social media live content and the characteristics of the crowd members. The program instructions are further executable to determine selected social media live content, based on matching the social media live content to the crowd members. The program instructions are further executable to match the selected social media live content to one or more advertisements, based on the one or more features and information of the one or more advertisements. The program instructions are further executable to determine one or more selected advertisements, based on matching the selected social media live content to the one or more advertisements. The program instructions are further executable to stream the selected social media live content on the one or more displays and display the one or more selected advertisements on the one or more displays.

In yet another aspect, a computer system for dynamically streaming social media live content and displaying advertisements is provided. The computer system comprises one or more processors, one or more computer readable tangible storage devices, and program instructions stored on at least one of the one or more computer readable tangible storage devices for execution by at least one of the one or more processors. The program instructions are executable to identify characteristics of crowd members, wherein the crowd members log in one or more wireless network access points and consume social media live content in an environment having one or more displays, and wherein one or more digital influencers produce social media live content in the environment. The program instructions are further executable to: extract one or more features of the social media live content; match the social media live content to the crowd members, based on the one or more features of the social media live content and the characteristics of the crowd members; determine selected social media live content, based on matching the social media live content to the crowd members; match the selected social media live content to one or more advertisements, based on the one or more features and information of the one or more advertisements; determine one or more selected advertisements, based on matching the selected social media live content to the one or more advertisements; stream the selected social media live content on the one or more displays; and display the one or more selected advertisements on the one or more displays.

### BRIEF DESCRIPTION OF THE SEVERAL VIEWS OF THE DRAWINGS

FIG. 1 is a systematic diagram illustrating a system of dynamically streaming social media live content and displaying advertisements on a public display, in accordance with one embodiment of the present invention.

FIG. 2 presents a flowchart showing operational steps of dynamically streaming social media live content and displaying advertisements on a public display, in accordance with one embodiment of the present invention.

FIG. 3 is a diagram illustrating components of a computer device, in accordance with one embodiment of the present invention.

FIG. 4 depicts a cloud computing environment, in accordance with one embodiment of the present invention.

FIG. 5 depicts abstraction model layers in a cloud computing environment, in accordance with one embodiment of the present invention.

### DETAILED DESCRIPTION

Embodiment of the present invention discloses an approach to promoting public displays and reducing the banner blindness by presenting social media live content being produced by digital influencers. In social media, content producers or digital influencers produce high visibility content in places containing public displays. The presence of the digital influencers can be beneficial to promoting public displays and reducing the banner blindness. In addition, the digital influencers are also benefitted from the public display visibility once the content produced by the digital influencer is presented.

In embodiments of the present invention, an environment with one or more public displays (often used for advertisements) and a number of people waiting in or passing through is considered. For example, the environment may be an airport, a train station, a bus terminal, or a shopping mall.

Embodiment of the present invention discloses an approach to identifying that one or more digital influencers are in the environment and are producing social media live content. The identification of the one or more digital influencers is through using or registering a Wi-Fi hotspot by the one or more digital influencers or through subscribing by the one or more digital influencers for a service. The one or more digital influencers identified are ranked by, but not limited to, features such as the number of followers and the number of views of the social media live content. Once the one or more digital influencers are identified, the social media live content being produced by the one or more digital influencers is selected and presented on the one or more public displays. Presenting selected social media live content is a way to increase the number of people looking at the one or more public displays before playing advertisements that are paid to the service.

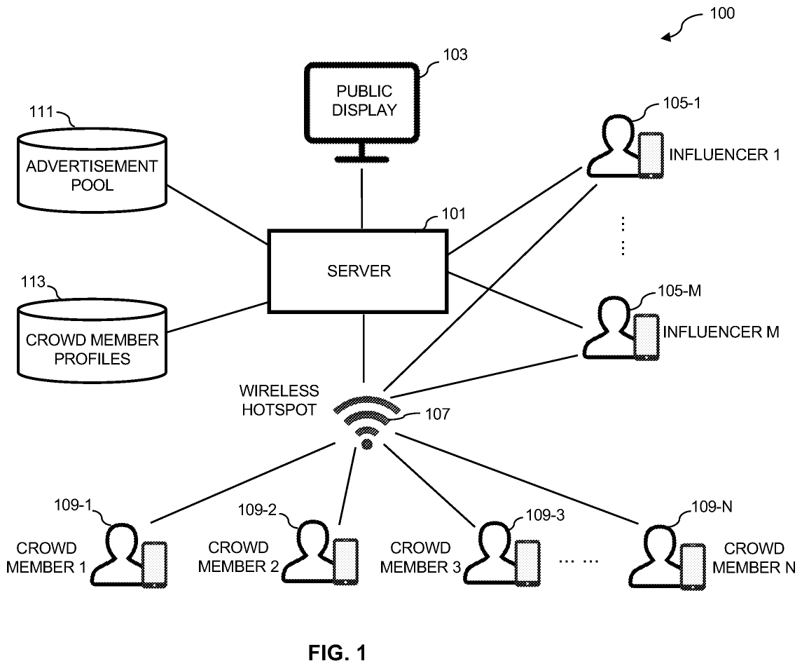

FIG. 1 is a systematic diagram illustrating system 100 of dynamically streaming social media live content and displaying advertisements on a public display, in accordance with one embodiment of the present invention. System 100 includes server 101 for a service of dynamically streaming social media live content and displaying advertisements on public display 103. In the embodiment presented in FIG. 1, public display 103 is used for streaming social media live content and displaying advertisements in an environment such as an airport, a train station, a bus terminal, or a shopping mall. In another embodiment, the environment may have multiple public displays. Server 101 controls public display 103 to dynamically stream social media live content and display advertisements.

System 100 further includes one or more digital influencers, as shown in FIG. 1, namely influencer 1 105-1, . . . , and influencer M 105-M. The digital influencers produce the social media live content and have followers. System 100 further includes the crowd members, namely crowd member 1 109-1, crowd member 2 109-2, crowd member 3 109-3, . . . , and crowd member N 109-N. The crowd members are in the environment where public displays are located and consume multimedia content in such environments. The crowd members may include followers of the one or more digital influencers and, in this case, consume the social media live content produced by the digital influencers.

System 100 further includes a wireless network access point—wireless hotspot 107. Wireless hotspot 107 provides wireless network access points for crowd member 1 109-1, crowd member 2 109-2, crowd member 3 109-3, . . . , and crowd member N 109-N. Wireless hotspot 107 may also provide wireless network access points for influencer 1 105-1, . . . , and influencer M 105-M. In another embodiment, the environment may have multiple wireless hotspots.

Crowd members, including crowd member 1 109-1, crowd member 2 109-2, crowd member 3 109-3, . . . , and crowd member N 109-N, log in wireless hotspot 107. For example, the crowd members may log in wireless hotspot 107 by using their social media accounts as a log-in method. Server 101 is capable to obtain information of the crowd members only by accessing log profiles of the crowd members and the log profiles are stored in wireless hotspot 107; thus, privacy of the crowd members is protected.

The digital influencers, including influencer 1 105-1, . . . , and influencer M 105-M, register the service provided by server 101 and accept terms of the service. The digital influencers log in server 101 to use the service. Once the digital influencer properly register and log in server 101, then server 101 is able to analyze and stream the social media live content produced by the digital influencers. In another embodiment, a digital influencer may connect the digital influencer's channel (such as a YouTube channel) to server 101.

Server 101 accesses log profiles in wireless hotspot 107 to identify characteristics (e. g., interests) of crowd member 1 109-1, crowd member 2 109-2, crowd member 3 109-3, . . . , and crowd member N 109-N. Server 101 matches the social media live content to crowd member 1 109-1, crowd member 2 109-2, crowd member 3 109-3, . . . , and crowd member N 109-N, based on characteristics (e. g., interests) of the crowd members and features of the social media live content. Server 101 matches the social media live content produced by the digital influencers to advertisements that are to be displayed on the public displays, based on the features of the social media live content and information of the advertisements. Server 101 streams selected social media live content and then displays selected advertisements on public display 103. Dynamically streaming social media live content and displaying advertisements on display 103 are based on analysis on characteristics (e. g., interests) of the crowd members, features of the social media live content produced by the digital influencers, and the information of the advertisements.

In one embodiment, server 101 is hosted by a computer device capable of communicating with other computer devices (such as computer devices of the one or more digital influencers) via a network. The network can be any combination of connections and protocols which support communications between server 101 and computer devices of the one or more digital influencers and support controlling over display 103 by server 101. For example, the network may be the Internet which represents a worldwide collection of networks and gateways to support communications between devices connected to the Internet; the network may be implemented as an intranet, a local area network (LAN), or a wide area network (WAN).

The network may be implemented as a wireless network. In the embodiment shown in FIG. 1, communications between server 101 and computer devices of the one or more digital influencers may be established through wireless hotspot 107. As an example shown in FIG. 1, the computer devices of the one or more digital influencers are connected to the wireless network through wireless hotspot 107. As another example shown in FIG. 1, the computer devices of the crowd members are connected to the wireless network through wireless hotspot 107. As yet another example shown in FIG. 1, server 101 accesses wireless hotspot 107. In addition, controlling over display 103 by server 101 may be implemented through a wireless network.

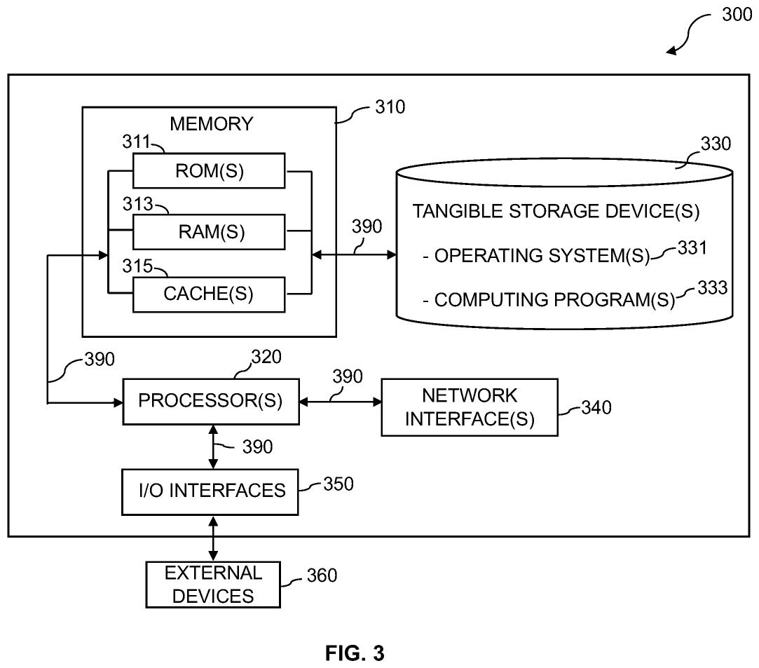

A computer device hosting server 101, computer devices of the one or more digital influencers, and computer devices of the crowd members may be desktop computers, mobile computer devices, mobile phones, or any other electronic devices or computing systems, capable of receiving input from a user and executing computer program instructions. The computer device is described in more detail in later paragraphs with reference to FIG. 3.

In another embodiment, server 101 may reside on a virtual machine or another virtualization implementation. The virtual machine or the virtualization implementation runs on a computer device. The computer device hosting the virtual machine, or the other virtualization implementation is described in more detail in later paragraphs with reference to FIG. 3.

System 100 further includes crowd member profiles database 113. Crowd member profiles database 113 includes profiles of crowd member 1 (109-1), crowd member 2 (109-2), crowd member 3 (109-3), . . . , and crowd member N (109-N). In one embodiment, for example, the profiles of the crowd members are obtained from social media logins; obtaining the profiles is consented by the crowd members. In another embodiment, for example, the profiles of the crowd members are obtained by collecting access statistics of a public network (e.g., Internet), such as access to unencrypted web pages. In one embodiment, crowd member profiles database 113 is located in a network, and server 101 retrieves the profiles of the crowd members via the network. In another embodiment, crowd member profiles database 113 may be hosted by server 101.

System 100 further includes advertisement pool 111. Advertisement pool 111 is a database including advertisements to be displayed on public display 103. It is under a contract to play the advertisements on public display 103. Additionally, advertisement pool 111 may include information or metadata of the advertisements, such as types of products or services that are advertised and target demographics. In one embodiment, advertisement pool 111 is located in a network, and server 101 retrieves the advertisements and the information or metadata via the network. In another embodiment, advertisement pool 111 may be hosted by server 101.

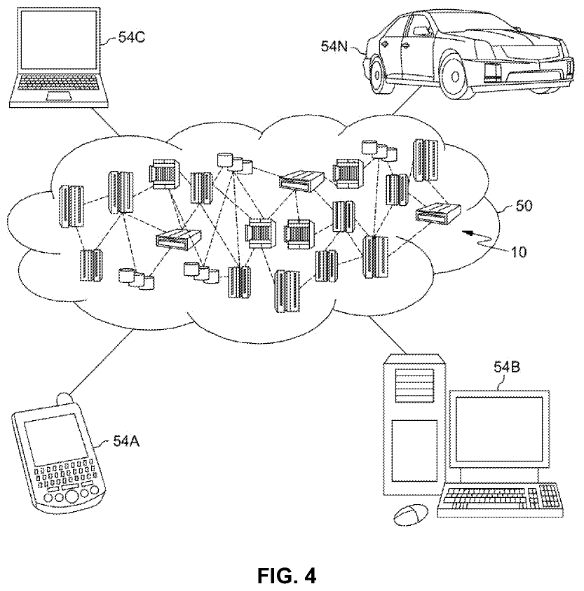

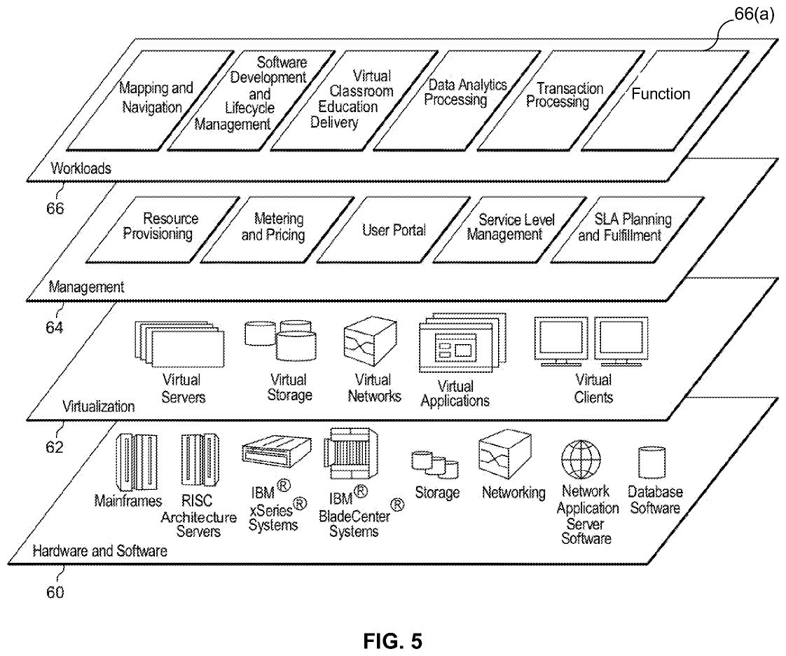

Server 101 may be implemented in a cloud computing environment. Crowd member profiles database 113 and/or advertisement pool 111 may also be in a cloud computing environment. The cloud computing environment is described in later paragraphs with reference to FIG. 4 and FIG. 5.

System 100 may be implemented in fog computing. The fog computing is an architecture in which a substantial amount of computation, storage, communication locally and routed over the internet backbone is implemented by using edge devices. An edge device provides an entry point into enterprise or service provider core networks. Fog computing is a decentralized computing structure associated with cloud computing and the internet of things (IoT), in which data and applications is in logical locations between a data source and the cloud. Different from the cloud computing, the fog computing emphasizes proximity to end-users and client objectives, dense geographical distribution and local resource pooling, latency reduction and backbone bandwidth savings and edge analytics/stream mining.

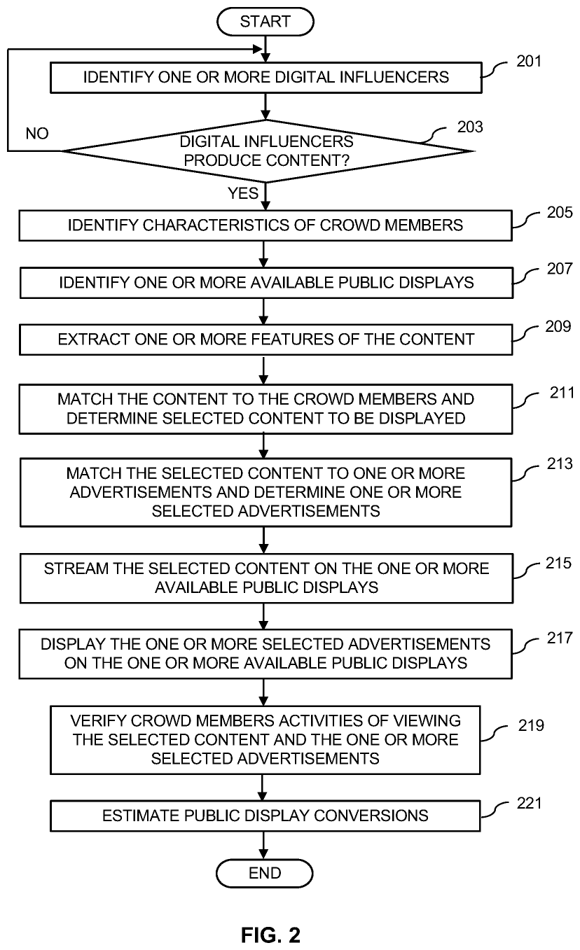

FIG. 2 presents a flowchart showing operational steps of dynamically streaming social media live content and displaying advertisements on a public display, in accordance with one embodiment of the present invention. The steps are implemented by a server (for example, server 101 shown in FIG. 1). At step 201, the server identifies one or more digital influencers in an environment with one or more public displays. In the embodiment shown in FIG. 1, server 101 identifies influencer 1 (105-1), . . . , and influencer M (105-M) in the environment with public display 103. When crowd member 1 109-1, crowd member 2 109-2, crowd member 3 109-3, . . . , and crowd member N 109-N connect to wireless hotspot 107 using social media accounts of the crowd members, server 101 verifies the number of the followers, the number of views of social media live content produced by the digital influencers, and other metrics allowing serve 101 to identify the digital influencers as outliers.

At step 203, the server determines whether the digital influencers produce the social media live content. Once the digital influencers are identified by the server, the server starts to verify whether or not the digital influencers are producing the social media live content in the environment with the one or more public displays. In the embodiment shown in FIG. 1, server 101 determines whether influencer 1 (105-1), . . . , and influencer M (105-M) in the environment with public display 103 produce the social media live content.

In response to determining the digital influencers not producing social media live content (NO branch of step 203), the server reiterates step 201. In response to determining the digital influencers producing the social media live content (YES branch of step 203), the server, at step 205, identifies characteristics (e.g., interests) of the crowd members. When the crowd members access social media live content via one or more hotspots in the environment, the server obtains or retrieves form the one or more hotspots information about how the crowd members interact with social media live content. Based on the information that indicates how the crowd members interact with the social media live content, the server identifies characteristics of the crowd members. From the one or more hotspots, the server obtains or retrieves the information of the crowd members only by accessing log profiles. While identifying the characteristics of the crowd members, the server preserves privacy of the crowd members; to do so, the server only obtains aggregated information from each hotspot. In the embodiment shown in FIG. 1, server 101 identifies characteristics of crowd member 1 109-1, crowd member 2 109-2, crowd member 3 109-3, . . . , and crowd member N 109-N. Server 100 obtains the aggregated information from wireless hotspot 107. To identify the characteristics of the crowd members, the server retrieves crowd member profiles from a database. The profiles of the crowd members are obtained from social media logins (upon consent of the crowd members) or obtained by collecting access statistics of a public network (such as access to unencrypted web pages). For example, in the embodiment shown in FIG. 1, server 101 retrieves the crowd member profiles from crowd member profiles database 113.

At step 207, the server identifies one or more available public displays in the environment. The one or more displays are used for streaming social media live content and displaying advertisements in the environment (such as an airport, a train station, a bus terminal, or a shopping mall). The server maps the one or more available public displays. In the embodiment shown in FIG. 1, server 101 identifies public display 103 available to stream the social media live content and display the advertisements in the environment.

At step 209, the server extracts one or more features of the social media live content which is produced by the digital influencers. For example, the server extracts a feature vector representing the social media live content. The feature vector can be created by considering natural language processing (e.g., deep learning) for audio content and/or computer vision algorithms (e.g., deep learning) for picture/video content. In the embodiment shown in FIG. 1, server 101 extracts the one or more features of the social media live content which is produced by influencer 1 (105-1), . . . , and influencer M (105-M) in the environment with public display 103.

At step 211, the server matches the social media live content to the crowd members, based on the one or more features (determined at step 209) and the characteristics (determined at step 205). At this step, the server determines selected social media live content, based on a result of matching the social media live content to the crowd members; the server determines the selected social media live content that matches the crowd members and is to be steamed on the one or more public displays. In the embodiment shown in FIG. 1, server 101 matches the social media live content to crowd member 1 109-1, crowd member 2 109-2, crowd member 3 109-3, . . . , and crowd member N 109-N; the social media live content is produced by influencer 1 (105-1), . . . , and influencer M (105-M); server 101 determines selected social media live content that matches the crowd members and is to be displayed on public display 103.

At step 213, the server matches the selected social media live content to one or more advertisements which are to be displayed on the one or more available public displays in the environment, based on the one or more features (determined at step 209) and information (e.g., metadata) of the one or more advertisements. Matching the selected social media live content to the one or more advertisements is performed by the server considering the feature vector obtained at step 209. The server retrieves the information of the one or more advertisements from a database. For example, the information (e.g., metadata) of the one or more advertisements includes types of products or services that are advertised and target demographics. In the embodiment shown in FIG. 1, server 101 retrieves the information (e.g., metadata) of the one or more advertisements from advertisement pool 111. At this step, the server determines one or more selected advertisements, based on a result of matching the selected social media live content to one or more advertisements; the server determines the one or more selected advertisements that match the selected social media live content and are to be displayed on the one or more public displays (for example, public display 103 in the embodiment shown in FIG. 1).

At step 215, the server streams the selected social media live content on the one or more available public displays. In the embodiment shown in FIG. 1, server 101 streams the selected social media live content on public display 103. At step 217, the server displays the one or more selected advertisements on the one or more available public displays. The server retrieves the one or more advertisements from a database of advertisement pool. In the embodiment shown in FIG. 1, server 101 retrieves the one or more advertisements from advertisement pool 111 and displays the one or more selected advertisements on public display 103.

At step 219, the server verifies crowd members activities of viewing the selected social media live content and the one or more selected advertisements. By assessing the crowd members activities, the server determines visibility of the selected social media live content and the one or more selected advertisements. In one embodiment, assessing the crowd members activities can be performed by considering the wireless bandwidth usage. While the crowd members are interacting with mobile devices, wireless network consumption presents fluctuations following predictable patterns of usage. When wireless network usage presents a drop that is bigger than expected, the server determines how many people have stopped interacting with mobile phones and started to view the selected social media live content and the one or more selected advertisements being presented on the one or more public displays. In another embodiment, assessing the crowd members activities can be performed by considering an app to connect to the one or more hotspots, and accelerometer data can be used to identify when users stop interacting with the mobile devices to watch the selected social media live content and the selected one or more advertisements. In yet another embodiment, in an environment with one or more surveillance cameras, images from the crowd members can be used for verifying crowd members activities and watching time while public displays are being used.

At step 221, the server estimates public display conversions, based on an analytical result on the crowd members activities at step 219. Estimating the public display conversion can be performed by considering how many users from the crowd members, who are targeted by the selected social media live content and the one or more selected advertisements, have been watching the one or more public displays during the delivery of the selected social media live content produced by the one or more digital influencers and the one or more selected advertisements.

FIG. 3 is a diagram illustrating components of computer device 300, in accordance with one embodiment of the present invention. It should be appreciated that FIG. 3 provides only an illustration of one implementation and does not imply any limitations with regard to the environment in which different embodiments may be implemented.

Referring to FIG. 3, computer device 300 includes processor(s) 320, memory 310, and tangible storage device(s) 330. In FIG. 3, communications among the above-mentioned components of computer device 300 are denoted by numeral 390. Memory 310 includes ROM(s) (Read Only Memory) 311, RAM(s) (Random Access Memory) 313, and cache(s) 315. One or more operating systems 331 and one or more computer programs 333 reside on one or more computer readable tangible storage device(s) 330.

Computer device 300 further includes I/O interface(s) 350. I/O interface(s) 350 allows for input and output of data with external device(s) 360 that may be connected to computer device 300. Computer device 300 further includes network interface(s) 340 for communications between computer device 300 and a computer network.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device, such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network (LAN), a wide area network (WAN), and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++, and conventional procedural programming languages, such as the C programming language, or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture, including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 4, illustrative cloud computing environment 50 is depicted. As shown, cloud computing environment 50 includes one or more cloud computing nodes 10 with which local computing devices are used by cloud consumers, such as mobile device 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N are intended to be illustrative only and that computing nodes 10 and cloud computing environment 50 can communicate with any type of computerized device over any type of network and/or network addressable connection (e.g., using a web browser).

Referring now to FIG. 5, a set of functional abstraction layers provided by cloud computing environment 50 (shown FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes, RISC (Reduced Instruction Set Computer) architecture based servers, servers, blade servers, storage devices, and networks and networking components. In some embodiments, software components include network application server software and database software.

Virtualization layer 62 provides an abstraction layer from which the following examples of virtual entities may be provided: virtual servers, virtual storage, virtual networks, including virtual private networks, virtual applications and operating systems, and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may include application software licenses. Security provides identity verification for cloud consumers and tasks, as well as protection for data and other resources. User Portal provides access to the cloud computing environment for consumers and system administrators. Service Level Management provides cloud computing resource allocation and management such that required service levels are met. Service Level Agreement (SLA) Planning and Fulfillment provide pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: Mapping and Navigation, Software Development and Lifecycle Management, Virtual Classroom Education Delivery, Data Analytics Processing, Transaction Processing, and functionality according to the present invention (Function 66a). In embodiments of the present invention, function 66a is dynamically streaming social media live content and displaying advertisements on a public display.

What is claimed is:

1. A computer-implemented method for dynamically streaming social media live content and displaying advertisements, the method comprising:
identifying, by a server, characteristics of crowd members, the crowd members logging in one or more wireless network access points and consume social media live content in an environment having one or more displays, one or more digital influencers producing social media live content in the environment;
extracting, by the server, one or more features of the social media live content;
matching, by the server, the social media live content to the crowd members, based on the one or more features of the social media live content and the characteristics of the crowd members;
determining, by the server, selected social media live content, based on the matching the social media live content to the crowd members;
matching, by the server, the selected social media live content to one or more advertisements, based on the one or more features and information of the one or more advertisements;
determining, by the server, one or more selected advertisements, based on the matching the selected social media live content to the one or more advertisements;
streaming, by the server, the selected social media live content on the one or more displays; and
displaying, by the server, the one or more selected advertisements on the one or more displays.

2. The computer-implemented method of claim 1, further comprising:
verifying, by the server, activities of the crowd members of viewing the selected social media live content and the one or more selected advertisements; and
estimating, by the server, display conversions, by considering how many of the crowd members have been watching the one or more displays.

3. The computer-implemented method of claim 1, further comprising:
identifying, by the server, the one or more digital influencers in the environment; and
determining, by the server, whether the one or more digital influencers produce the social media live content in the environment.

4. The computer-implemented method of claim 1, further comprising:
identifying, by the server, the one or more displays in the environment.

5. The computer-implemented method of claim 1, further comprising:
retrieving, by the server, information from log profiles of the one or more wireless network access points in the environment, wherein based on the information from the log profiles the server identifies the characteristics of the crowd members; and
wherein the information from the log profiles indicates how the crowd members interact with the social media live content when the crowd members log into the one or more wireless network access points to access the social media live content.

6. The computer-implemented method of claim 1, further comprising:
retrieving, by the server, profiles of the crowd members, wherein based on the profiles of the crowd members the server identifies the characteristics of the crowd members; and
wherein the profiles of the crowd members are either obtained from social media logins of the crowd members or obtained by collecting access statistics of a network.

7. The computer-implemented method of claim 1, further comprising:
retrieving, by the server, from an advertisement pool, the one or more advertisements and the information of the one or more advertisements.

8. A computer program product for dynamically streaming social media live content and displaying advertisements, the computer program product comprising one or more computer-readable tangible storage devices and program instructions stored on at least one of the one or more computer-readable tangible storage devices, the program instructions executable to:
identify, by a server, characteristics of crowd members, the crowd members logging in one or more wireless network access points and consume social media live content in an environment having one or more displays, one or more digital influencers producing social media live content in the environment;
extract, by the server, one or more features of the social media live content;
match, by the server, the social media live content to the crowd members, based on the one or more features of the social media live content and the characteristics of the crowd members;
determine, by the server, selected social media live content, based on matching the social media live content to the crowd members;
match, by the server, the selected social media live content to one or more advertisements, based on the one or more features and information of the one or more advertisements;
determine, by the server, one or more selected advertisements, based on matching the selected social media live content to the one or more advertisements;
stream, by the server, the selected social media live content on the one or more displays; and
display, by the server, the one or more selected advertisements on the one or more displays.

9. The computer program product of claim 8, further comprising the program instructions executable to:
verify, by the server, activities of the crowd members of viewing the selected social media live content and the one or more selected advertisements; and
estimate, by the server, display conversions, by considering how many of the crowd members have been watching the one or more displays.

10. The computer program product of claim 8, further comprising the program instructions executable to:
identify, by the server, the one or more digital influencers in the environment; and
determine, by the server, whether the one or more digital influencers produce the social media live content in the environment.

11. The computer program product of claim 8, further comprising the program instructions executable to:
identify, by the server, the one or more displays in the environment.

12. The computer program product of claim 8, further comprising the program instructions executable to:
retrieve, by the server, information from log profiles of the one or more wireless network access points in the environment, wherein based on the information from the log profiles the server identifies the characteristics of the crowd members; and
wherein the information from the log profiles indicates how the crowd members interact with the social media live content when the crowd members log into the one or more wireless network access points to access the social media live content.

13. The computer program product of claim 8, further comprising the program instructions executable to:
retrieve, by the server, profiles of the crowd members, wherein based on the profiles of the crowd members the server identifies the characteristics of the crowd members; and
wherein the profiles of the crowd members are either obtained from social media logins of the crowd members or obtained by collecting access statistics of a network.

14. The computer program product of claim 8, further comprising the program instructions executable to:
retrieve, by the server, from an advertisement pool, the one or more advertisements and the information of the one or more advertisements.

15. A computer system for dynamically streaming social media live content and displaying advertisements, the computer system comprising:
one or more processors, one or more computer readable tangible storage devices, and program instructions stored on at least one of the one or more computer readable tangible storage devices for execution by at least one of the one or more processors, the program instructions executable to:
identify, by a server, characteristics of crowd members, the crowd members logging in one or more wireless network access points and consume social media live content in an environment having one or more displays, one or more digital influencers producing social media live content in the environment;
extract, by the server, one or more features of the social media live content;
match, by the server, the social media live content to the crowd members, based on the one or more features of the social media live content and the characteristics of the crowd members;
determine, by the server, selected social media live content, based on matching the social media live content to the crowd members;
match, by the server, the selected social media live content to one or more advertisements, based on the one or more features and information of the one or more advertisements;
determine, by the server, one or more selected advertisements, based on matching the selected social media live content to the one or more advertisements;
stream, by the server, the selected social media live content on the one or more displays; and
display, by the server, the one or more selected advertisements on the one or more displays.

16. The computer system of claim 15, further comprising the program instructions executable to:
verify, by the server, activities of the crowd members of viewing the selected social media live content and the one or more selected advertisements; and
estimate, by the server, display conversions, by considering how many of the crowd members have been watching the one or more displays.

17. The computer system of claim 15, further comprising the program instructions executable to:
identify, by the server, the one or more digital influencers in the environment; and
determine, by the server, whether the one or more digital influencers produce the social media live content in the environment.

18. The computer system of claim 15, further comprising the program instructions executable to:
identify, by the server, the one or more displays in the environment.

19. The computer system of claim 15, further comprising the program instructions executable to:
retrieve, by the server, information from log profiles of the one or more wireless network access points in the environment, wherein based on the information from the log profiles the server identifies the characteristics of the crowd members; and
wherein the information from the log profiles indicates how the crowd members interact with the social media live content when the crowd members log into the one or more wireless network access points to access the social media live content.

20. The computer system of claim 15, further comprising the program instructions executable to:
retrieve, by the server, profiles of the crowd members, wherein based on the profiles of the crowd members the server identifies the characteristics of the crowd members; and
wherein the profiles of the crowd members are either obtained from social media logins of the crowd members or obtained by collecting access statistics of a network.
